(19) United States
(12) Patent Application Publication
(10) Pub. No.: US 2013/0158966 A1
(43) Pub. Date: Jun. 20, 2013

(54) METHOD OF COLLISION SIMULATION FOR SPINNING BALL

(71) Applicants: Seong Min BAEK, Daejeon (KR); Jong Sung Kim, Daejeon (KR); Myung Gyu Kim, Daejeon (KR); IL Kwon Jeong, Daejeon (KR)

(72) Inventors: Seong Min BAEK, Daejeon (KR); Jong Sung Kim, Daejeon (KR); Myung Gyu Kim, Daejeon (KR); IL Kwon Jeong, Daejeon (KR)

(73) Assignee: Electronics and Telecommunications Research Institute, Daejeon (KR)

(21) Appl. No.: 13/563,661

(22) Filed: Jul. 31, 2012

(30) Foreign Application Priority Data
Dec. 15, 2011 (KR) 10-2011-0135907

(51) Int. Cl. G06G 7/48

(52) U.S. Cl. 703/6

(57) ABSTRACT

Disclosed is a method of simulating a collision trajectory of a ball which rotates and moves in a virtual sports game (for example, golf, baseball, soccer, or tennis). A method of collision simulation for a spinning ball includes: detecting collision of a spinning ball; calculating a velocity of the ball after colliding considering rotation of the ball and the friction with the ground; calculating a center point of the ball after colliding; and rolling and stopping the ball. The detecting of collision of a spinning ball includes: checking whether a segment connecting a center point in a previous position of the ball and a center point in the current position collides with the ground; and generating vectors of a lower part of the ball to check whether the vectors collide with the ground.

### CROSS-REFERENCE TO RELATED APPLICATIONS

This application claims priority to and the benefit of Korean Patent Application No. 10-2011-0135907 filed in the Korean Intellectual Property Office on Dec. 15, 2011, the entire contents of which are incorporated herein by reference.

### TECHNICAL FIELD

The present invention relates to a method of simulating a collision trajectory of a ball that rotates and moves in a virtual sports game (for example, golf, baseball, soccer, or tennis).

### BACKGROUND ART

The most important thing in a physical interactive sports game that uses a ball is to calculate a movement trajectory of a ball. The movement of the ball starts by hitting, throwing, or kicking the ball and then the ball lands on the ground after a predetermined time has elapsed. In this case, depending on a velocity, a direction, rotation, an elastic coefficient of the ball, and a collision coefficient of the ground, and a slope of the ground, a bouncing direction after colliding is varied. The ball is bounced several times and then rolled. The rolling of the ball is affected by the frictional force of the ground and the slope of the ground.

As described above, the rigid body simulation that applies an impulse when the collision of an object occurs according to the related art has a problem in that the change caused by strong rotation according to various collision characteristics cannot be precisely represented. Specifically, when an impulse for a sphere-shaped object is calculated, the rotational force becomes “0” because a vector from a center of the ball to a colliding point is on the same line as a normal vector direction of the colliding surface. Some of the related arts suggest a bouncing direction of a ball when collision of the ball occurs, but do not mention a case when the ball strongly rotates.

Currently, there are lots of virtual sports games, which are developed based on the rigid body simulation. However, as mentioned above, in the virtual sports games based on the rigid body simulation, it is not sufficient to precisely simulate the bouncing trajectory of the ball that is bounced after colliding with the ground. Specifically, it is difficult to calculate a bouncing direction and a velocity after colliding with respect to the ball that rapidly and strongly rotates, for example, after a golf ball is struck.

### SUMMARY OF THE INVENTION

The present invention has been made in an effort to suggest a method of detecting a precise colliding point by a method of checking collision of a ball with the ground in two stages, suggest a method of calculating the impulse at the time of collision and determining a colliding direction and a velocity by applying a torque and a kinetic friction force, suggest a method of calculating a center point of the ball in consideration of the colliding point and the colliding direction directly after colliding, and suggest a condition that the bouncing status of the ball is changed into a rolling status, a condition that a rolling status is transited into a bouncing status, and a condition that the rolling status is transited into a stopped status.

An exemplary embodiment of the present invention provides a method of collision simulation for a spinning ball, including: detecting collision of a spinning ball; calculating a velocity of the ball after colliding considering rotation of the ball and the friction with the ground; calculating a center point of the ball after colliding; and rolling and stopping the ball. The detecting of collision of a spinning ball includes: checking whether a segment connecting a center point in a previous position of the ball and a center point in the current position collides with the ground; and generating vectors of a lower part of the ball to check whether the vectors collide with the ground. The calculating of a velocity of the ball after colliding considering rotation of the ball and the friction with the ground includes: classifying the direction and the velocity of the ball after colliding into î, ĵ, \hat{k} axis components; calculating the velocity in the ĵ axis direction by applying an impulse and a property of the hardness of the ground; and calculating the velocity in the î, \hat{k} axis directions by applying the change of the velocity due to the friction with the ground and change of the velocity due to the rotation of the ball. In the calculating of a velocity of the ball after colliding considering rotation of the ball and the friction with the ground, the rotation of the ball before colliding and the rotation of the ball due to the friction with the ground after colliding are considered. The calculating of a center point of the ball after colliding calculates the center point of the ball after colliding by applying a ratio of the distance from the previous position to the current position and a distance from the center point of the ball directly after colliding to the current position.

Another exemplary embodiment of the present invention provides a method of collision simulation for a spinning ball, including: determining transition from a flying status of the ball to a bouncing status depending on whether the ball collides; determining transition from the bouncing status of the ball to a rolling status depending on a height of the ball; determining transition from the rolling status of the ball to a stopped status depending on a movement velocity and a movement distance of the ball; and determining transition from the rolling status of the ball to the bouncing status depending on a distance between the ball and the ground. The determining whether the ball collides includes: checking whether a segment connecting a center point in a previous position of the ball and a center point in the current position collides with the ground; and generating lower part vectors νᵢ of the ball to check whether the vectors collide with the ground.

According to exemplary embodiments of the present invention, it is possible to precisely simulate a collision trajectory of a ball that rotates at high speed and improve the reality of a sports game that uses a ball by providing various trajectory changes of a ball which may occur in actual field.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating an example of status changes in collision simulation for a ball according to an exemplary embodiment of the present invention.

FIG. 2 is a diagram illustrating a two stage collision check of a ball and the ground in the collision simulation for a ball according to an exemplary embodiment of the present invention.

FIG. 3 is a diagram illustrating an example of generating a lower part vector for the two-stage collision check for a ball in the collision simulation for a ball according to an exemplary embodiment of the present invention.

FIG. 4 is a diagram illustrating an example of a basic axis for calculating a direction after colliding when the ball collides on the ground in the collision simulation for a ball according to an exemplary embodiment of the present invention.

FIG. 5 is a diagram illustrating an example of a collision check when the ball rolls along the ground in the collision simulation for the ball according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, a method of collision simulation for a ball according to an exemplary embodiment of the present invention will be described in detail with reference to the accompanying drawings.

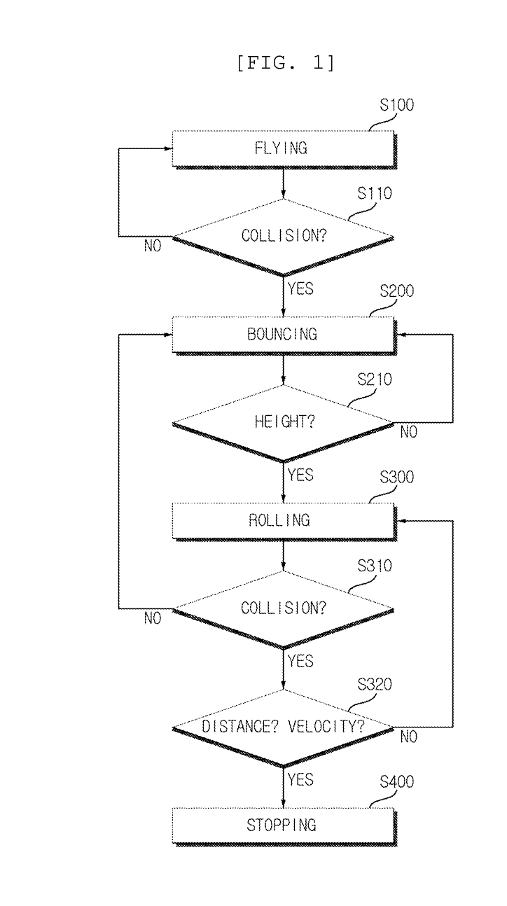

FIG. 1 illustrates a status diagram for simulating a movement trajectory of a ball after colliding according to an exemplary embodiment of the present invention.

Referring to FIG. 1, a ball has four statuses. It is assumed that a ball is flying in an initial status (S100). When the ball is in a flight status, it is checked whether the ball collides with the ground (S110). If the ball collides with the ground, the ball is in a bouncing status (S200). In this case, the collision check uses two-stage check.

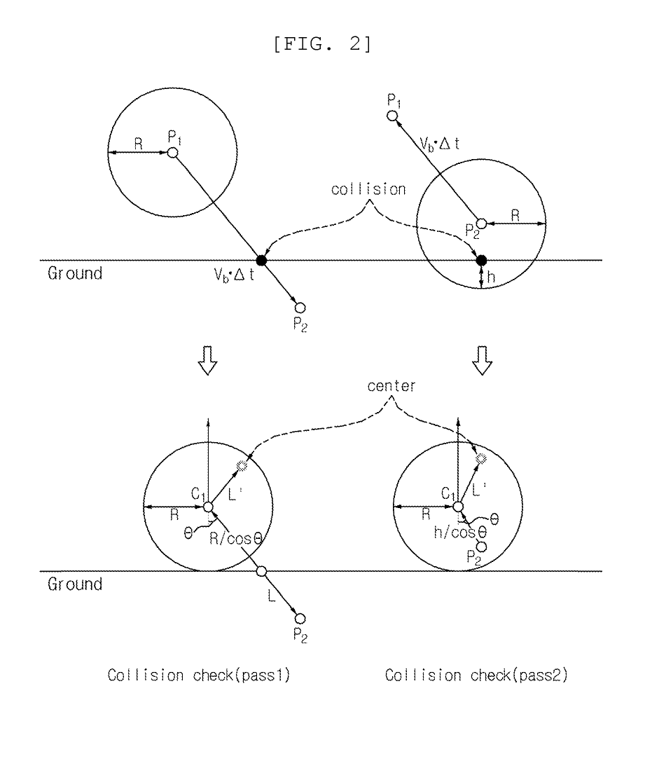

FIG. 2 illustrates an example of a two-stage collision check and positional movement of a center point directly after colliding.

Referring to FIG. 2, a segment connecting center point P₁ of a ball and P₂ is generated using a previous position P₁ and a current position P₂ of the ball in the first stage and then it is checked whether the segment P̅₁̅P̅₂̅ collides with a surrounding object such as the ground. If the segment P̅₁̅P̅₂̅ intersects with a surface, it is understood that the ball collides with the object.

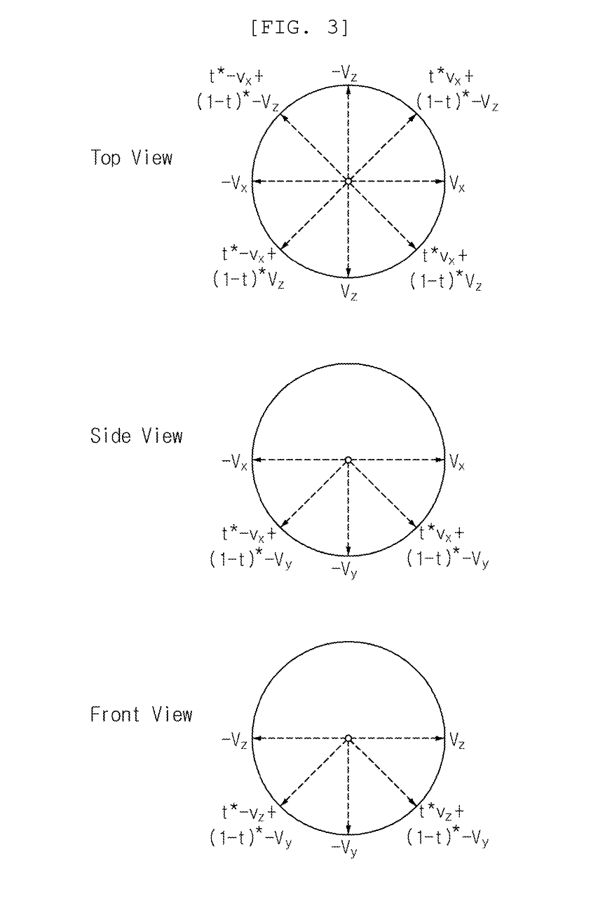

If the segment does not intersect with the surface in the first stage, the second stage check is proceeded. In the second stage check, even though the segment connecting the center point P₁ of the ball and P₂ does not collide with the ground, since the ball actually has a volume, it is checked whether vectors from the center point P₂ of the ball to the surface collide with the surrounding environment. Here, the ground may be curved or collide with the surrounding obstacles. Therefore, νᵢ vectors whose length is a radius R of the ball are generated using the P₂ as a starting point to detect the collision. Here, the νᵢ vectors are sampled in order to check whether the lower part of the ball collides with the surrounding obstacles. The νᵢ vectors, as shown in FIG. 3, generate an intermediate vector with respect to X-axis, −X-axis, Z-axis, and -Z-axis using an interpolation method when P₂ is considered as an origin point. The intermediate vector generated on an xz plane and a vector on a -y axis are interpolated to generate the νᵢ vector. In this case, the number of the intermediate vectors may be adjusted depending on the size of the ball. FIG. 3 shows an example of generating one vector (t=0.5) in the middle of every vector as a top view, a side view, and a front view. If necessary, the upper part of the ball may be checked.

If a point where the segment intersects with the surface is detected (that is, if the collision is detected in the first stage), the position of the center point of the ball at the moment of colliding the ball with the ground is calculated using the intersecting point, which may be called as an intermediate stage for detecting a precise position of the ball after colliding. If collision(intersecting) point is moved by R/cos θ in a direction from the collision point to P1, that point becomes a position of the center point C₁ of the ball at the moment of collision. When the collision is detected in the second stage, if the center point P₂ is moved by h/cos θ in the P₁ direction, which becomes a position of the center point C₁ of the ball at the moment of collision. Here, it should be considered that the remaining distance from the center point C₁ directly after colliding to P₂ is calculated in order to make smooth collision trajectory. If it is assumed that the length of the segment P̅₁̅P̅₂̅ is L1 and the distance from the center point C₁ of the ball at the moment of collision to P₂ is L₂, the ratio (t=L₂/L₁) of the lengths of the two segments is used to calculate an actual center point C₂ of the ball after colliding. Since the position of the final collision center point C₂ may be calculated when the direction and velocity after colliding are known, the position of the final collision center point will be mentioned again after determining the velocity and the direction after colliding.

After calculating the center point C₁ of the ball at the moment of collision, an impulse j is calculated. The impulse refers to a change of momentum in a predetermined period of time. In the rigid body simulation, the impulse is used to calculate a velocity and rotation after colliding when two objects collide. The impulse is calculated by following Equation 1.

$$j = \frac{- ( 1 + e ) * ( {v}_{a} + {w}_{a} \times {r}_{ap} ) \cdot N}{1 / {m}_{a} + {( {r}_{ap} \times n )}^{2} / {I}_{a}} \qquad [ Equation 1 ]$$

In Equation 1, e refers to an elastic coefficient, νₐ refers to a velocity before colliding, ωₐ refers to an angular velocity before colliding, γₐₚ refers to a vector from the center point of the ball to the collision point, N refers to a normal vector of the ground at the collision position, mₐ refers to a mass of the ball, and Iₐ refers to an inertial moment.

When a sphere shaped object such as a ball collides with a surface, since the vector γₐₚ from the center of the ball to the collision point is present on the same line as the normal vector N of the ground, the change by the rotation becomes “0”, which means that the force by the rotation of the ball may be not applied to the change of the trajectory.

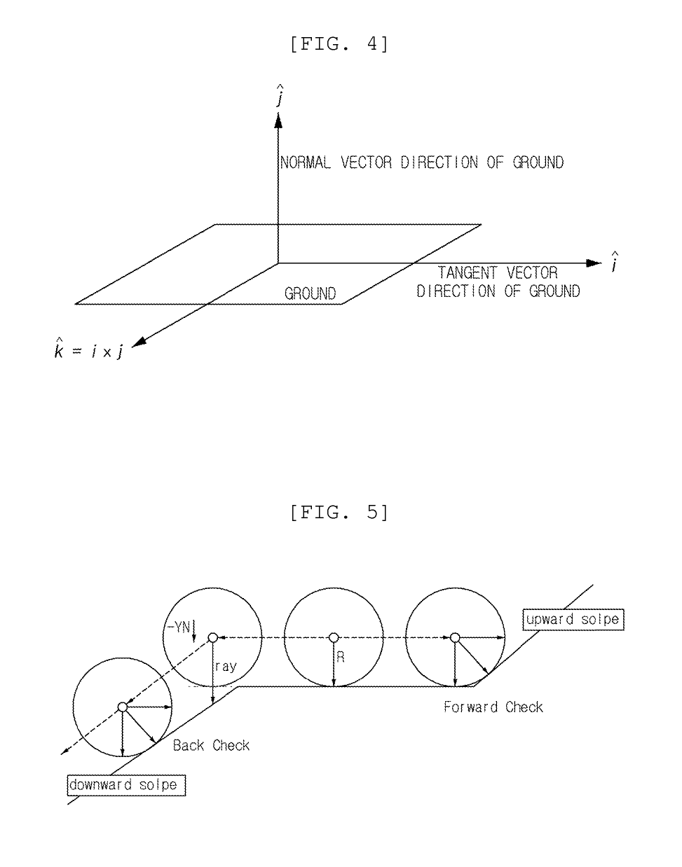

In order to solve the above problems, a component that the ball bounces toward the normal vector direction of the ground is separated from a component that the ball proceeds to a tangent vector direction of the ground. In this case, the referential axis is shown in FIG. 4. ĵ axis is a unit vector indicating a component that the ball upwardly bounces and matches with the normal vector direction of the ground. In the experiment, the bouncing height of the ball is determined by an elasticity of the ball and an elasticity of the ground regardless of the rotation of the ball. Therefore, in order to calculate a bouncing velocity of the ball, only an impulse from which a component relating to the rotation is removed is used as in

Equation 2.

$$j = \frac{- ( 1 + e ) * ( {v}_{a} \cdot N )}{1 / {m}_{a}} \qquad [ Equation 2 ]$$

Using Equation 2 and following Equation 3, the velocity νₙ of the ball after colliding in the ĵ axis direction is calculated.

νₙ=μₕ*jN [Equation 3]

In Equation 3, μₕ is a numerical value indicating the hardness of the ground. For example, the harder the ground, the more the ball bounces. In contrast, the softer the ground, the less the ball bounces.

The velocity in the proceeding direction after the ball collides with the ground is calculated as follows. If the proceeding direction of the ball on î, \hat{k} plane is b_{dir} the proceeding direction is calculated by Equation 4.

b_{dir}=normalize((N×νₐ)×N) [Equation 4]

The friction by the collision is related with coefficient of kinetic friction of the ground and the impulse and represented by Equation 5.

ν_{f}=−b_{dir}*(μ_{f}*j) [Equation 5]

In Equation 5, νⱼ refers to a velocity by the friction, μⱼ refers to a coefficient of kinetic friction of the ground, and j refers to the impulse. Since the velocity by the friction is a component that interrupts the movement of the ball, the direction of the friction is opposite to the proceeding direction of the ball.

The change of the velocity by the rotation varies depending on a rotational direction and a rotational velocity of the ball. When the ball rotates by the friction with the ground at the moment when the flying ball collides with the ground, the collision trajectory is not affected by the rotation. An amount of rotation ω_{f} of the ball caused by the friction is calculated by Equation 6.

ω_{f}=(N×b_{dir})*((νₐ·b_{dir})+ν_{f})/R [Equation 6]

In Equation 6, N×b_{dir} refers to the rotational direction of the ball and R refers to a radius of the ball. A rotational axis of the ball is related with the proceeding direction and the rotational velocity is obtained by dividing the velocity in the proceeding direction into the radius.

When the rotation of the ball before colliding is larger than the rotation caused by the friction with the ground as mentioned above, the rotation of the ball affects the velocity after colliding, which may be represented by Equation 7. When the rotation of the ball just before colliding is ωₐ, if the direction of ωₐ is different from the rotation ωⱼ calculated by Equation 6, the summation of two values is set as a rotation value ((ω_{b}=ωₐ+ω_{f})) after colliding. In this case, only when |ωₐ|>|ω_{f}|, the rotation affects the change of the velocity. If not, the velocity becomes “0”.

$$\begin{matrix}{v}_{r} = R * ( N \times {w}_{b} ) ; & if ( \vert {w}_{a} \vert > \vert {w}_{f} \vert ) \\ {v}_{r} = 0 ; & otherwise\end{matrix} \qquad [ Equation 7 ]$$

When the directions of the two rotational axes are same, the difference between the two rotation values is set as the rotation value ((ω_{b}=ωₐ−ω_{f})) after colliding. In this case, only when |ωₐ|>|ω_{f}|, the rotation affects the change of the velocity. If not, the velocity becomes “0”.

Using the above Equations, the final velocity after colliding is calculated by Equation 8.

ν_{b}=νₐ(νₙ+ν_{f}+νᵣ) [Equation 8]

When the direction and the velocity of the ball after colliding are determined, the final position C₂ of the moved center point may be calculated. The movement direction is the direction ν_{b} of the ball after colliding and the movement distance L′ is calculated by Equation 9.

L′=|ν_{b}|*(dt*t) [Equation 9]

In Equation 9, dt refers to the time when the position of the ball moves from P₁ to P₂ and t, as mentioned above, refers to a ratio of the length of the segment P̅₁̅P̅₂̅ and the distance from the center point C₁ of the ball directly after colliding to P₂ (0≦t≦1).

When using the above-mentioned method, various realistic bouncing effects by the rotation of the ball may be obtained (for example, a phenomenon that a golf ball bounces backwardly by the back spin).

After the ball bounces several times, the ball may roll or stop. The condition that the bouncing status is transited into the rolling status is defined by the bouncing height (ĵ axis direction) of the ball after colliding (S210). As described above, the largest height h of the ball may be calculated in advance using the velocity of the ball after colliding. Equation 10 is an equation that calculates the height when the ball bounces. The largest height is calculated by repeating Δt and the height in the ĵ axis direction is calculated by an inner product of the largest height and the normal vector of the ground.

h=νΔt+½gt²

h′=h·N [Equation 10]

If the bouncing height h′ of the ball is lower than a predetermined height, the status of the ball is transited into the rolling status (S300).

When the ball rolls, the collision with the ground is one of important factors. In order to allow the ball to naturally move along the curve of the ground without digging out the ground, the second stage of the above-mentioned two stage collision check is used in order to precisely detect the collision point not only in the upward direction, but also in the downward direction when the ground is curved. The difference from the second stage of the above-mentioned two stage collision check is that the ball is leaded to always collide the lower part of the ball with the ground by directing the moving direction of the ball toward a direction (−γN) opposite to the normal vector of the ground as represented in Equation 11. In Equation 11, γ is a very small constant. As described above, if the center point moves, it is possible to always detect the collision with the ground even when the slope of the ground is changed such as in the downward direction or the upward direction.

b_{dir}=normalize (b_{dir}−γN) [Equation 11]

A rolling frictional force is generated in a direction opposite to the moving direction of the ball and a rolling velocity may be varied by the slope of the ground. Therefore, the velocity when the ball rolls is calculated by Equation 12 by considering the rolling frictional force and the slope of the ground. In Equation 12, φ refers to an angle of the slope of the ground and μ_{γ} refers to the rolling frictional coefficient.

ν_{b2}|=(|ν_{b1}|+gt sin φ)−μᵣgt cos φ [Equation 12]

If the collision of the ball with the ground is not detected by the collision check, it means that the ball enters the downward slope. In this case, a ray is downwardly (-y axis direction) irradiated in a predetermined length to check whether the ball collides with the ground. If the collision point with the ground is not detected in the predetermined length (S310), it means that the ball drops due to the steep slope. Accordingly, the status of the ball is transited into the bouncing status again (S200).

After the collision check, if the center point of the ball is adjusted by calculating the collision position as described above, the ball looks as if the ball always rolls on the ground. If the movement distance of the rolling ball becomes smaller than δ_{d} and the velocity in the proceeding direction is smaller than δ_{ν} (S320), the status of the ball transited into the stop status and the simulation is completed (S400).

The present invention considers the elastic coefficients of the ball and the ground and the amount of rotation of the ball in order to simulate the bouncing force of a ball that rotates and moves after colliding and represents the transition into the rolling status and the stopping step, which allows the realistic simulation for the ball. The method suggested in the present invention may be also applied to all sports games that use a ball.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of collision simulation for a spinning ball, comprising:
detecting collision of a spinning ball;
calculating a velocity of the ball after colliding considering rotation of the ball and the friction with the ground;
calculating a center point of the ball after colliding; and
rolling and stopping the ball.

2. The method of claim 1, wherein the detecting of collision of a spinning ball includes:
checking whether a segment connecting a center point in a previous position of the ball and a center point in the current position collides with the ground; and
generating vectors of a lower part of the ball to check whether the vectors collide with the ground.

3. The method of claim 1, wherein the calculating of a velocity of the ball after colliding considering rotation of the ball and the friction with the ground includes:
classifying the direction and the velocity of the ball after colliding into î, ĵ, \hat{k} axis components;
calculating the velocity in the ĵ axis direction by applying an impulse and a property of the hardness of the ground; and
calculating the velocity in the î,\hat{k} axis directions by applying the change of the velocity due to the friction with the ground and the change of the velocity due to the rotation of the ball.

4. The method of claim 1, wherein in the calculating of a velocity of the ball after colliding considering rotation of the ball and the friction with the ground, the rotation of the ball before colliding and the rotation of the ball due to the friction with the ground after colliding are considered.

5. The method of claim 1, wherein the calculating of a center point of the ball after colliding calculates the center point of the ball after colliding by applying a ratio of the distance from the previous position of the ball to the current position and a distance from the center point of the ball directly after colliding to the current position.

6. A method of collision simulation for a spinning ball, comprising:
determining transition from a flying status of the ball to a bouncing status depending on whether the ball collides;
determining transition from the bouncing status of the ball to a rolling status depending on a height of the ball;
determining transition from the rolling status of the ball to a stopped status depending on a movement velocity and a movement distance of the ball; and
determining transition from the rolling status of the ball to the bouncing status depending on a distance between the ball and the ground.

7. The method of claim 6, wherein the determining whether the ball collides, includes:
checking whether a segment connecting a center point in a previous position of the ball and a center point in the current position collides with the ground; and
generating lower part vectors of the ball to check whether the vectors collide with the ground.
